(19) United States
(12) Patent Application Publication
(10) Pub. No.: US 2008/0185822 A1
(43) Pub. Date: Aug. 7, 2008

(54) Airbag cover with controlled tear lines

(75) Inventors: Andreas Maria Joachim Jonietz, Vigo (ES); Luis Barandela Iglesias, Vigo (ES); Enrique Pajon Fustes, Vigo (ES)

Correspondence Address: LADAS & PARRY LLP, 26 WEST 61ST STREET, NEW YORK, NY, 10023, US

(73) Assignee: DALPHI METAL ESPANA, S.A.

(21) Appl. No.: 12/009,621

(22) Filed: Jan. 18, 2008

(30) Foreign Application Priority Data
Jan. 19, 2007 (EP) 07381004.6

(51) Int. Cl. B60R 21/215

(52) U.S. Cl. 280/728.3

(57) ABSTRACT

The objective of the present invention is to provide an airbag cover with efficient control means of the tear lines designed on its outer surface so that the cover breaks in a plurality of flaps facilitating the release of the airbag at the required moment for its deployment. This objective is achieved with an airbag cover for an automotive vehicle formed by a container body provided so as to be fixed to the airbag module and an upper surface of a plastic material provided so as to be visible in the vehicle including a plurality of tear lines on the inner face of said upper surface formed by weakened areas predetermined by the lines where the tear will occur during the deployment of the airbag cushion, said tear lines being designed to form flaps after said deployment which are joined to the cover at the area of such flaps defined between the ends of two tear lines close to the container body.

### FIELD OF THE INVENTION

The present invention relates to an airbag cover for automotive vehicles.

### BACKGROUND OF THE INVENTION

Airbag covers having an upper surface including predefined tear lines to facilitate the release of the airbag when its deployment is required to protect a vehicle occupant in the event of a collision are currently known.

It is obviously desirable for the tearing of the airbag cover to occur without any part of such cover becoming detached, and therefore said tear lines are normally designed so that the upper surface can be split into flaps joined to the cover only in areas close to its edges. These flaps must be able to rotate about said joining area, allowing the release of the airbag, and they must remain joined to the cover so as to prevent any detachment of material which may harm the vehicle occupants.

However, given that the tearing of these flaps through said tear lines may occur in very different conditions, the suitable control thereof is problematic. It must be taken into consideration that the airbag may deploy in a very broad temperature range, e.g. between −35° C. and +85° C. and that within this range, the behavior of the cover, which is usually made of a plastic material, may be very different since its physical and mechanical properties considerably vary with the temperature.

Some proposals to that effect are known, and the following documents must be mentioned.

Patent document GB 2,314,305 describes an airbag cover having areas with different thicknesses defined by different tear lines.

Patent document U.S. Pat. No. 5,573,267 describes an airbag cover with reinforcement elements in areas close to the tear lines.

Patent document US 2004/0262891 describes an airbag cover in which the tear lines have areas with different thicknesses at their end part.

However the automotive industry continuously demands improvements of known solutions and the present invention is aimed at fulfilling this demand.

### SUMMARY OF THE INVENTION

The objective of the present invention is to provide an airbag cover with efficient control means of the tear lines designed on its outer surface so that the cover breaks in a plurality of flaps facilitating the release of the airbag at the required moment for its deployment.

This objective is achieved with an airbag cover for an automotive vehicle formed by a container body provided so as to be fixed to the airbag module and an upper surface of a plastic material provided so as to be visible in the vehicle including a plurality of tear lines on the inner face of said upper surface formed by weakened areas predetermined by the lines where the tear will occur during the deployment of the airbag cushion, said tear lines being designed to form flaps after said deployment which are joined to the cover at the area of such flaps defined between the ends of two tear lines close to the container body, the ends of said tear lines being designed in at least one of said flaps with a curved shape with its end parts aimed towards the inside of said upper surface, and the cover including reinforcement ribs to prevent detachment of the flap, such ribs being located close to said end parts of the tear lines and being joined both to the container body and to the inner part of the upper surface of the cover.

Other features and advantages of the present invention will be understood from the following detailed description of an illustrative and non-limiting embodiment of its object in relation to the attached drawings.

### DESCRIPTION OF THE FIGURES

FIG. 1 shows a perspective view of the inside of an airbag cover according to the present invention.

FIGS. 2a and 2b are partial schematic views of an airbag cover according to the present invention while it is inactive and after it is torn due to the deployment of the airbag.

FIGS. 3a and 3b show partial sectional views of an airbag cover according to the present invention while it is inactive and after it is torn due to the deployment of the airbag.

### DETAILED DESCRIPTION OF THE INVENTION

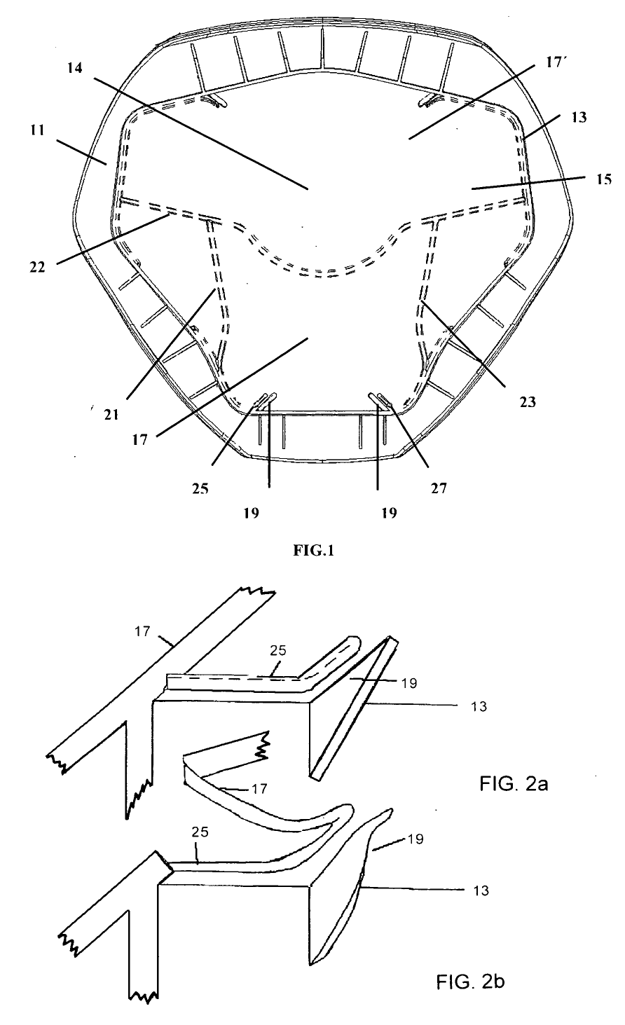

According to FIG. 1, an airbag cover 11 formed by a container body 13 provided so as to be fixed to the airbag module and an upper surface 15 provided to be visible in the vehicle can be seen, in the central part of which a decorative element 14 is arranged which normally bears the logo of the automobile manufacturer.

The cover 11 is made of a plastic material, and preferably of a thermoplastic elastomer. These materials can be easily processed and allow suitable controlling the size and quality of the parts made using them.

As can be seen in this figure, the inner part of the upper surface 15 includes a plurality of tear lines 21, 22, 23 formed by weakened areas predetermined by the lines where the tearing of the upper surface 15 of the cover will occur during deployment of the cushion of the airbag, said tear lines 21, 22, 23 being designed so that a plurality of flaps 17, 17′ is formed on the upper surface 15, allowing the release of the airbag.

Flap 17 in particular is defined by the tear lines 21, 22, 23 and once these lines are torn, it remains joined to the cover 11 in the area thereof defined between the ends of the two tear lines 21, 23 close to the container body 13, therefore having a hinge function when the airbag is deployed and causes the tear lines 21, 22, 23 to tear.

According to all the figures which show a preferred embodiment of the present invention, it can be seen that the main features thereof for achieving better control of the tear lines 21, 22, 23 than the control provided by the prior art are the presence of the angular reinforcement ribs 19 in the hinge area of the flap 17 and the curved shape of the ends of the tear lines 21, 23.

The angular ribs 19 are arranged to the side of the end parts 25, 27 of the tear lines 21, 23 and are arranged perpendicular to the upper surface 15 and oblique to the container body 13.

For their part, the ends of tear lines 21, 23 are designed with a curved shape with their end parts 25, 27 aimed towards the inside of said upper surface 15.

Each angular rib 19 and each end part 25, 27 of the tear lines 21, 23 are arranged in turn such that a hypothetical line tangential thereto at the end would be considerably parallel to the angular rib 19.

With these features it is achieved that the material of the flap 17 bends and elongates without tearing at the end parts 25, 27 of the tear lines 21, 23. Therefore the radius of gyration increases without reaching the elastic limit of the material, preventing detachments.

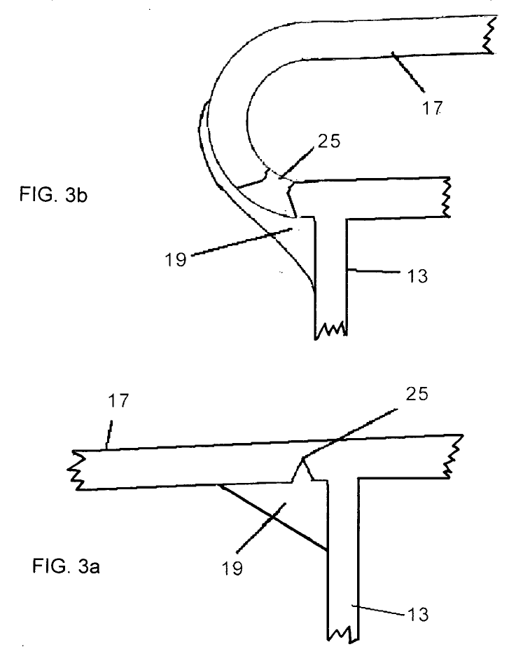

The triangular shaped ribs 19 with variable thickness prevent the detachment of the flap 17 at the end parts 25, 27 of the tear lines 21, 23 since they work under tension and torsion at the same time. The twisting of the ribs 19 (FIGS. 2b and 3b) resulting from working under torsion in particular entails a significant absorption of energy.

The reinforcement ribs 19 may have trapezoidal or curved shapes in addition to the triangular shape as a person skilled in the art will understand.

In addition, in another embodiment of the present invention, more than one reinforcement rib 18 can be used next to the end of each tear line.

Although one embodiment of the invention has been described and represented, it is evident that modifications comprised within the scope thereof can be introduced in the invention-, and it is not limited to said embodiment but rather to the content of the following claims.

1. An airbag cover (11) for automotive vehicles formed by a container body (13) provided so as to be fixed to the airbag module and an upper surface (15) made of a plastic material so as to be visible in the vehicle including a plurality of tear lines (21, 22, 23) on the inner face of said upper surface (15) formed by weakened areas defined by the lines where its tearing will occur during the deployment of the cushion of the airbag, said tear lines (21, 22, 23) being designed so as to form flaps (17, 17′) after said deployment which remain joined to the cover (11) in the area thereof defined between the ends of two tear lines (21, 23) close to the container body (13), characterized in that in at least one of said flaps (17):
a) the ends of said tear lines (21, 23) are designed with a curved shape with its end parts (25, 27) aimed towards the inside of said upper surface (15);
b) the cover (11) includes reinforcement ribs (19) to prevent the detachment of the flap (17) which are located close to said end parts (25, 27) of the tear lines (21, 23) and are joined both to the container body (13) and to the inner part of the upper surface (15) of the cover (11).

2. An airbag cover (11) for automotive vehicles according to claim 1, characterized in that said reinforcement ribs (19) have any of the following shapes: triangular, trapezoidal and curved.

3. An airbag cover (11) for automotive vehicles according to claim 2, characterized in that said end parts (25, 27) are designed such that a hypothetical tangent line on its end forms an acute angle with the container body (13).

4. An airbag cover (11) for automotive vehicles according to claim 3, characterized in that said reinforcement ribs (19) are arranged in a plane parallel to said hypothetical tangent line.

5. An airbag cover (11) for automotive vehicles according to claim 2, characterized in that the cover includes more than one reinforcement rib (19) at the end of each tear line (21, 23).

6. An airbag cover (11) for automotive vehicles according to claim 1, characterized in that the plastic material of the upper surface (15) is a thermoplastic elastomer.
